(19) United States
(12) Patent Application Publication
(10) Pub. No.: US 2026/0120081 A1
(43) Pub. Date: Apr. 30, 2026

(54) VERIFICATION USING BLOCKCHAIN SMART CONTRACT

(71) Applicant: Visa International Service Association, San Francisco, CA (US)

(72) Inventors: Bryce Jurss, Leander, TX (US); Peter Cooling, Raleigh, NC (US); Wassif Alqraini, San Francisco, CA (US); Alex Ma, Portland, OR (US)

(73) Assignee: Visa International Service Association, P.O. Box 8999, CA (US)

(21) Appl. No.: 19/471,931

(22) PCT Filed: Apr. 18, 2023
(86) PCT No.: PCT/US2023/018928

§ 371 Date: Oct. 2, 2025

(51) Int. Cl. G06Q 20/36; G06Q 20/38; G06Q 20/40

(52) U.S. Cl. CPC G06Q 20/36; G06Q 20/3821; G06Q 20/385; G06Q 20/401; G06Q 2220/00

(57) ABSTRACT

A method is disclosed. The method includes transmitting a verification request comprising a wallet account identifier associated with a digital wallet to a smart contract on a blockchain network or a smart contract application associated with the smart contract. The smart contract or the smart contract application verifies the wallet account identifier using a blockchain on the blockchain network. The method also includes receiving from the smart contract on the blockchain network or the smart contract application, a verification response verifying the wallet account. The method further includes initiating transmitting to an authorizing entity computer, an authorization request message comprising a credential associated with the wallet account identifier.

### CROSS-REFERENCES TO RELATED APPLICATIONS

None.

### BACKGROUND

Many digital assets can only be purchased using the digital currencies (e.g., Bitcoin, Ethereum, Tether) of the digital wallets (e.g., cryptocurrency wallets). Also, some digital services also require digital currencies not just assets. (e.g., using swapping services). For users who only have fiat wallets, transactions involving such digital assets that can be purchased only through the digital currencies can be complex, because fiat wallets and digital wallets are in different ecosystems. Complicated intermediary systems are used between fiat currency systems and digital currency systems (e.g., systems that include digital wallets) to allow them to interact with each other. Improved and less complicated methods and systems that allow for more complex fiat and digital currency transactions are needed.

Embodiments of the disclosure address this problem and other problems individually and collectively.

### SUMMARY

One embodiment of the invention includes a method. The method comprises: transmitting, by a computer, a verification request comprising a wallet account identifier associated with a digital wallet to a smart contract on a blockchain network or a smart contract application associated with the smart contract, wherein the smart contract or the smart contract application verifies the wallet account identifier using a blockchain on the blockchain network; receiving, by the computer from the smart contract on the blockchain network or the smart contract application, a verification response verifying the wallet account identifier; and initiating transmitting to an authorizing entity computer, an authorization request message comprising a credential associated with the wallet account identifier, wherein the authorizing entity computer authorizes the authorization request message.

Another embodiment of the invention includes a token service computer comprising: a processor; and a computer readable medium comprising code, executed by the processor for performing operations comprising: transmitting a verification request comprising a wallet account identifier associated with a digital wallet to a smart contract on a blockchain network or a smart contract application associated with the smart contract, wherein the smart contract or the smart contract application verifies the wallet account identifier using a blockchain on the blockchain network; receiving, from the smart contract on the blockchain network or the smart contract application, a verification response verifying the wallet account identifier; and initiating transmitting to an authorizing entity computer, an authorization request message comprising a credential associated with the wallet account identifier, wherein the authorizing entity computer authorizes the authorization request message.

Another embodiment includes a method comprising: receiving, by a smart contract application residing on a computer, information of a user; receiving, by the smart contract application on the computer, an authorization from a smart contract on a blockchain network to proceed with provisioning of a wallet account identifier; sending by the smart contract application on the computer a request to provision the wallet account identifier to a token service computer; receiving, by the smart contract application on the computer, a response approving of the provisioning of the wallet account identifier; and transmitting, by the smart contract application on the computer to the smart contract on the blockchain network, the request to provision the wallet account identifier to a user device of the user, wherein the smart contract thereafter initiates provisioning of the wallet account identifier to a user device of the user.

Another embodiment of the invention includes a computer comprising: a processor; and a non-transitory computer readable medium comprising a smart contract application and code, executable by the processor to perform operations comprising: receiving, by a smart contract application residing on a computer, information of a user; receiving, by the smart contract application on the computer, an authorization from a smart contract on a blockchain network to proceed with provisioning of a wallet account identifier; sending by the smart contract application on the computer a request to provision the wallet account identifier to a token service computer; receiving, by the smart contract application on the computer, a response approving of the provisioning of the wallet account identifier; and transmitting, by the smart contract application on the computer to the smart contract on the blockchain network, the request to provision the wallet account identifier to a user device of the user, wherein the smart contract thereafter initiates the provisioning of the wallet account identifier to a user device of the user.

Another embodiment includes a method comprising: receiving, by a token service computer from an access device, an authorization request message comprising a wallet account identifier comprising a wallet account number; transmitting, by the token service computer, a verification request comprising the wallet account identifier comprising the wallet account number to a smart contract on a blockchain network or a smart contract application associated with the smart contract, wherein the smart contract or the smart contract application verifies the wallet account identifier comprising the wallet account number using a blockchain on the blockchain network; receiving, by the token service computer from the smart contract on the blockchain network or the smart contract application, a verification response verifying the wallet account identifier comprising the wallet account number; transmitting, by the token service computer to an authorizing entity computer, the authorization request message comprising a credential, wherein the authorizing entity computer authorizes the authorization request message and transmits an authorization response message to the token service computer; receiving, by the token service computer, the authorization response message; and transmitting, by the token service computer, the authorization response message to the access device.

Another embodiment includes a token service computer comprising: a processor; and a non-transitory computer readable medium comprising code, executable by the processor, to perform a method comprising: receiving, from an access device, an authorization request message comprising a wallet account identifier comprising a wallet account number; transmitting a verification request comprising the wallet account identifier comprising the wallet account number to a smart contract on a blockchain network or a smart contract application associated with the smart contract, wherein the smart contract or the smart contract application verifies the wallet account identifier comprising the wallet account number using a blockchain on the blockchain network; receiving, from the smart contract on the blockchain network or the smart contract application, a verification response verifying the wallet account identifier comprising the wallet account number; transmitting, to an authorizing entity computer, the authorization request message comprising a credential, wherein the authorizing entity computer authorizes the authorization request message and transmits an authorization response message to the token service computer; receiving, by the token service computer, the authorization response message; and transmitting, by the token service computer, the authorization response message to the access device.

These and other embodiments are described in further detail below with reference to the Drawings and the Detailed Description.

### BRIEF DESCRIPTION OF THE DRAWINGS

FIG. 1 shows a system and a flow diagram of provisioning a wallet account identifier according to some embodiments.

FIG. 2 shows a system and a flow diagram of performing a transaction using a wallet account identifier according to some embodiments.

FIG. 3 shows a system and a flow diagram of receiving a digital assets using a wallet account identifier after performing a transaction according to some embodiments.

FIG. 4 shows a system and a flow diagram of sending a digital asset to another party using a wallet account identifier according to some embodiments.

FIG. 5 shows a system and a flow diagram of converting the digital currency into fiat currency using a wallet account identifier.

FIG. 6 shows a block diagram of a token service computer according to some embodiments.

FIG. 7 shows a block diagram of a user device according to embodiments.

FIG. 8 shows a block diagram of a node computer in a blockchain network.

FIG. 9 shows a portion of a blockchain.

### DETAILED DESCRIPTION

Prior to discussing embodiments of the disclosure, some terms can be described in further detail.

A “user device” may be a device that is operated by a user. Examples of user devices may include a mobile phone, a smart phone, a card, a personal digital assistant (PDA), a laptop computer, a desktop computer, a server computer, a vehicle such as an automobile, a thin-client device, a tablet PC, etc. Additionally, user devices may be any type of wearable technology device, such as a watch, earpiece, glasses, etc. The user device may include one or more processors capable of processing user input. The user device may also include one or more input sensors for receiving user input. There are a variety of input sensors capable of detecting user input, such as accelerometers, cameras, microphones, etc. The user input obtained by the input sensors may be from a variety of data input types, including, but not limited to, audio data, visual data, or biometric data. The user device may comprise any electronic device that may be operated by a user, which may also provide remote communication capabilities to a network. Examples of remote communication capabilities include using a mobile phone (wireless) network, wireless data network (e.g., 3G, 4G or similar networks), Wi-Fi, Wi-Max, or any other communication medium that may provide access to a network such as the Internet or a private network.

A “user” may include an individual. In some embodiments, a user may be associated with one or more personal accounts and/or mobile devices. The user may also be referred to as a cardholder, account holder, or consumer in some embodiments. In some embodiments, a resource provider can be a user and may operate a user device.

An “interaction” may include a reciprocal action or influence. An interaction can include a communication, contact, or exchange between parties, devices, and/or entities. Example interactions include a transaction between two parties and a data exchange between two devices. In other embodiments, an interaction can include a payment transaction in which two devices can interact to facilitate a payment.

“Interaction data” can include data related to and/or recorded during an interaction. In some embodiments, interaction data can be transaction data of the network data. Transaction data can comprise a plurality of data elements with data values.

An “amount” can include a quantity of something. An amount can include a total of a thing or things in number, size, value, or extent.

An “authorizing entity”may be an entity that authorizes a request. Examples of an authorizing entity may be an issuer, a governmental agency, a document repository, an access administrator, etc. An authorizing entity may operate an authorizing entity computer. An “issuer” may refer to a business entity (e.g., a bank) that issues and optionally maintains an account for a user. An issuer may also issue payment credentials stored on a user device, such as a cellular telephone, smart card, tablet, or laptop to the consumer.

An “acquirer” may typically be a business entity (e.g., a commercial bank) that has a business relationship with a particular merchant or other entity.

Some entities can perform both issuer and acquirer functions. Some embodiments may encompass such single entity issuer-acquirers. An acquirer may operate an acquirer computer, which can also be generically referred to as a “transport computer.”

A “resource provider” may be an entity that can provide a resource such as goods, services, information, and/or access. Examples of resource providers includes merchants, data providers, transit agencies, governmental entities, venue and dwelling operators, etc.

The term “verification” and its derivatives may refer to a process that utilizes information to determine whether an underlying subject is valid under a given set of circumstances. Verification may include any comparison of information to ensure some data or information is correct, valid, accurate, legitimate, and/or in good standing.

The term “public/private key pair” may include a pair of linked cryptographic keys generated by an entity. The public key may be used for functions such as encrypting a message to send to the entity or for verifying a digital signature which was supposedly made by the entity. The private key may be used for functions such as decrypting a received message or applying a digital signature. The public key can be authorized by a certificate authority, which can store the public key in a database and distribute it to any other entity which requests the public key. The private key can be kept in a secure storage medium and will usually only be known to the entity. However, the cryptographic systems described herein may feature key recovery mechanisms for recovering lost keys and avoiding data loss. Public and private keys may be in any suitable format, including those based on Rivest-Shamir-Adleman (RSA) or elliptic curve cryptography (ECC).

A “digital signature” may include a type of electronic signature. A digital signature may encrypt documents with digital codes that can be difficult to duplicate. In some embodiments, a digital signature may refer to the result of applying an algorithm based on a public/private key pair, which allows a signing party to manifest, and a verifying party to verify, the authenticity and integrity of a document. The signing party acts by means of the private key and the verifying party acts by means of the public key. This process certifies the authenticity of the sender, the integrity of the signed document and the so-called principle of nonrepudiation, which does not allow disowning what has been signed. A certificate or other data that includes a digital signature by a signing party is said to be “signed” by the signing party.

A “smart contract” can include a program stored on a blockchain that runs when predetermined conditions are met. Smart contracts on a blockchain can store a state and can execute computations. They can automate a workflow, triggering the next action when conditions are met.

A “token service computer” can include a system that that services tokens or wallet account identifiers. In some embodiments, a token service computer can facilitate requesting, determining (e.g., generating) and/or issuing tokens, as well as maintaining an established mapping of tokens to primary account numbers (PANs), and both or either of which can be linked to wallet account identifiers, in a repository (e.g., token vault). In some embodiments, the token service computer may establish a token assurance level for a given token to indicate the confidence level of the token or wallet account identifier to PAN binding. The token service computer may include or be in communication with a token vault where the generated tokens or wallet account identifiers are stored. The token service computer may support token processing of payment transactions submitted using tokens or wallet account identifiers by de-tokenizing the token or resolving a wallet account identifier to obtain the actual PAN.

A “token request message” may be an electronic message for requesting a token. A token request message may include information usable for identifying a payment account or digital wallet, and/or information for generating a payment token. For example, a token request message may include payment credentials, mobile communication device identification information (e.g., a phone number or MSISDN), a digital wallet account identifier, information identifying a tokenization service provider, a merchant identifier, a cryptogram, and/or any other suitable information. Information included in a token request message can be encrypted (e.g., with an issuer-specific key). In some embodiments, the token request message may include a flag or other indicator specifying that the message is a token request message.

A “token response message” may be a message that responds to a token request. A token response message may include an indication that a token request was approved or denied. A token response message may also include a payment token, mobile communication device identification information (e.g., a phone number or MSISDN), a digital wallet account identifier, information identifying a tokenization service provider, a merchant identifier, a cryptogram, and/or any other suitable information. Information included in a token response message can be encrypted (e.g., with an issuer-specific key). In some embodiments, the token response message may include a flag or other indicator specifying that the message is a token response message.

An “authorization request message” may be a message that requests permission to conduct an interaction. For example, an authorization request message may include an electronic message that is sent to a payment processing network and/or an issuer of a payment card to request authorization for a transaction. An authorization request message according to some embodiments may comply with (International Organization of Standardization) ISO 8583, which is a standard for systems that exchange electronic transaction information associated with a payment made by a consumer using a payment device or payment account.

The authorization request message may include a primary account number that may be associated with a payment device or payment account, or a wallet account identifier associated with a payment account number. An authorization request message may also comprise additional data elements corresponding to “identification information” including, by way of example only: a service code, a CVV (card verification value), a dCVV (dynamic card verification value), an expiration date, etc. An authorization request message may also comprise “transaction information,” such as any information associated with a current transaction, such as the transaction amount, merchant identifier, merchant location, etc., as well as any other information that may be utilized in determining whether to identify and/or authorize a transaction.

An “authorization response message” may be an electronic message reply to an authorization request message. In some embodiments, it may be generated by an issuing financial institution or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the payment processing network) to the merchant's access device (e.g., POS equipment) that indicates approval of the transaction. The code may serve as proof of authorization. As noted above, in some embodiments, a payment processing network may generate or forward the authorization response message to the merchant.

A “processor” may include a device that processes something. In some embodiments, a processor can include any suitable data computation device or devices. A processor may comprise one or more microprocessors working together to accomplish a desired function. The processor may include a CPU comprising at least one high-speed data processor adequate to execute program components for executing user and/or system-generated requests. The CPU may be a microprocessor such as AMD's Athlon, Duron and/or Opteron; IBM and/or Motorola's PowerPC; IBM's and Sony's Cell processor; Intel's Celeron, Itanium, Pentium, Xeon, and/or Xscale; and/or the like processor(s).

A “memory” may be any suitable device or devices that can store electronic data. A suitable memory may comprise a non-transitory computer readable medium that stores instructions that can be executed by a processor to implement a desired method. Examples of memories may comprise one or more memory chips, disk drives, etc. Such memories may operate using any suitable electrical, optical, and/or magnetic mode of operation.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

Embodiments can include the use of a wallet account identifier (e.g., wallet account number (WAN)) which is associated with a digital wallet, which is in turn associated with one or more credentials. Examples of credentials can include a primary account number (PAN), a payment token, a public key and/or private key of a public/private key pair, etc. The wallet account identifier can be created using a smart contract on a blockchain maintained by a blockchain network, in conjunction with a smart contract application and a token service computer.

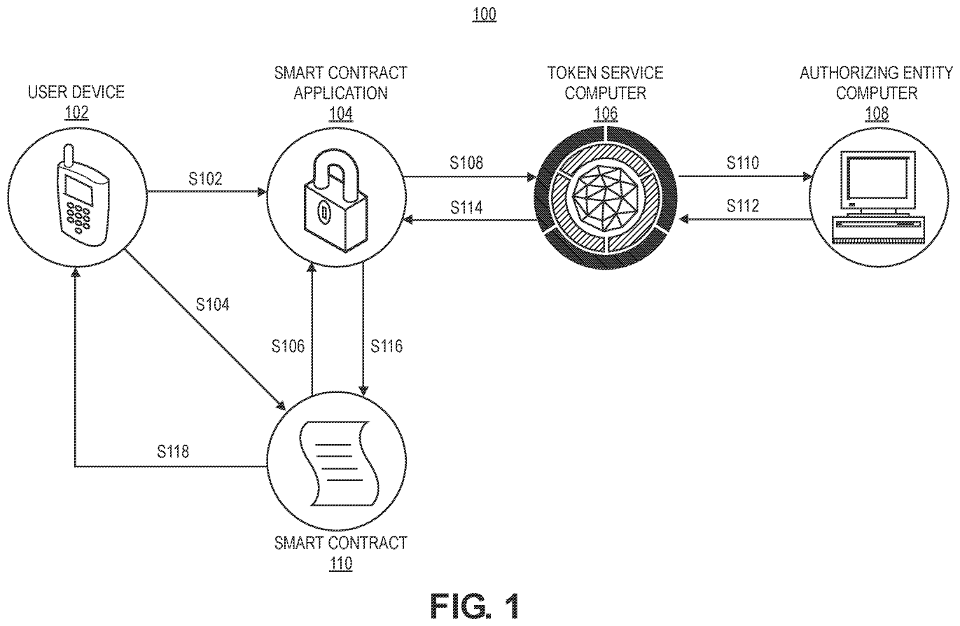

FIG. 1 shows a system and a flow diagram for provisioning a wallet account identifier to a user device 102 according to some embodiments. The system can comprise a user device 102 that is operated by a user (not shown), a smart contract application 104 that can reside on a computer such as the user device 102 or a cloud server computer (not shown), a smart contract 110 that can reside on a blockchain network managing a blockchain, a token service computer 106, and an authorizing entity computer 108.

For simplicity of illustration, a certain number of components are shown in FIG. 1 (and the other Figures). It is understood, however, that embodiments of the invention may include more than one of each component. In addition, some embodiments of the invention may include fewer than or greater than all of the components shown in FIG. 1 (or the other Figures).

Messages between at least the devices of system in FIG. 1 (and the other Figures in this application) can be transmitted using a secure communications protocols such as, but not limited to, File Transfer Protocol (FTP); HyperText Transfer Protocol (HTTP); Secure Hypertext Transfer Protocol (HTTPS), SSL, ISO (e.g., ISO 8583) and/or the like. The communications network may include any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. The communications network can use any suitable communications protocol to generate one or more secure communication channels. A communications channel may, in some instances, comprise a secure communication channel, which may be established in any known manner, such as through the use of mutual authentication and a session key, and establishment of a Secure Socket Layer (SSL) session.

The user device 102 can be a mobile phone of the user. Other examples of user devices are described above. In some embodiments, the user device 102 can include a smart contract application 104. In other embodiments, the smart contract application can reside on a remote server computer such as a cloud server computer. The user device 102 may also have a private-public key pair of a digital wallet that can be used to generate a digital signature. In some embodiments, the digital wallet can be accessed by a digital wallet application on the user device 102. In some embodiments, the smart contract application 104 can include a user interface that the user device 102 can use to relay user information to the token service computer 106. In some embodiments, the smart contract application 104 can be a software development kit (SDK) implemented by different entities or may be implemented by the same entity facilitating the token service computer 106. For example, the smart contract application 104 can be part of a digital wallet application on the user device 102, where the digital wallet application has a public-private key pair associated with it. The public-private key pair can be used by the digital wallet application to conduct cryptocurrency transactions. In some embodiments, the public/private key pair corresponds to an account on blockchain and thus is used to conduct cryptocurrency transactions. In other embodiments, the digital wallet application and the smart contract application can be separate applications, but can interact with each other.

As noted above, the token service computer 106 can include a system that services tokens. It can also help to facilitate the provisioning of a wallet account identifier, and transaction processing using the wallet account identifier.

In some embodiments, the token service computer 106 can be part of a processing network computer that may be configured to provide authorization services, and clearing and settlement services for payment transactions. A processing network computer may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular includes a Visa Integrated Payments (VIP) system which processes authorization requests and a Base II system which performs clearing and settlement services.

The authorizing entity computer 108 can be operated by an entity such as an issuer of an account (e.g., a fiat account). It can authorize the tying of an account credential to a wallet account identifier. It can also authorize or decline transactions conducted using account credentials, but initiated by wallet account identifiers.

The smart contract 110 can reside on a blockchain that is managed by a blockchain network. The smart contract 110 can execute code for provisioning wallet account identifiers and other functions. The blockchain network storing the smart contract can be public or private, and the blockchain that it manages can either be public or private.

A method for provisioning a wallet account identifier can be described with reference to FIG. 1. A user operating the user device 102 (e.g., a mobile phone, laptop computer, etc.) may wish to obtain a wallet account identifier for a pre-existing or newly created digital wallet.

In step S102, the user operating the user device 102 can provide information of the user to the smart contract application 104. The user information can comprise digital wallet information such as a public key of a public/private key pair associated with the digital wallet or a user device identifier (e.g., a phone number, IMEI number, etc.) associated with the user device 102. The user device 102 may already have a digital wallet application on it (e.g., a Bitcoin wallet) or a digital wallet application can be installed, but not yet registered, on the user device 102. In other embodiments, the user device 102 communication with the smart contract application 104 can cause the installation of a new wallet application on the user device 102. Whether the wallet application is a new wallet application or a pre-existing wallet application on the user device 102, the user may provide other user information to the smart contract application 104. Examples of other user information may include a credential such as primary account number (PAN), as well as a cryptogram such as a CVV, CVV2, DCVV, or DCVV2, an expiration date, etc. Other types of user information can include communication information such as an email address, phone number, etc., or user identifiers such as usernames, nicknames, etc. It may also include personal information for KYC (know your customer) or AML (anti-money laundering) compliance.

In step S104, the user device 102 can provide authorization to share the user information with the token service computer 106 to the smart contract 110. In this regard, the smart contract application 104 can have an address (e.g., an IP address) of the smart contract 110 and the user device 102 can use the address to communicate with the smart contract 110. After communicating with the smart contract 110, the smart contract 110 can provide terms and conditions regarding the receipt and use of the requested wallet account identifier. The user of the user device 102 can then review the terms and conditions.

In some embodiments, the user device 102 can use the private key of a public-private key pair to sign data that is provided to the user device 102 by either the smart contract application 104 or the smart contract 110 to produce a digital signature. In some embodiments, the data that is signed with the private key could be the terms and conditions as well as a timestamp of when the data was presented to and/or signed by the user device 102. The public-private key pair can be created in conjunction with the creation of or registration with the digital wallet application on the user device 102. The digital signature can serve as proof that the user of the user device 102 has agreed to the terms and conditions of the smart contract 110, and that the user and the user device 102 are legitimate owners of the digital wallet (i.e., because the user device 102 has the private key). In some embodiments, the user device 102 could have the private key or has the authority/ability/access to generate a valid signature using private keys. The digital signature can then be stored on the blockchain that holds the smart contract. The blockchain can also store the digital signature along with the subsequently created wallet account identifier and any of the other user information described above. The blockchain can be managed by a blockchain network (not shown in FIG. 1).

In step S106, after the user device 102 provides the digital signature to the smart contract 110, the smart contract 110 can notify the smart contract application 104 that it has authorized the provisioning of the wallet account identifier. In some embodiments, the smart contract application 104 can also a verify a signature if needed.

In step S108, the smart contract application 104, upon receiving the information of the user and the authorization to provision, can send a request to provision the wallet account identifier to the token service computer 106.

In step S110, the token service computer 106 can send a provisioning request message to allow for the provisioning of a wallet account number linked to a primary account number (PAN) and optionally the creation of a payment token (e.g., PAN token) to the authorizing entity computer 108. The provisioning request message can comprise at least the previously provided user information including but not limited to the primary account number, cryptogram, and expiration date associated with an account managed by the authorizing entity computer 108. In some embodiments, the provisioning request message can be in the form of an ISO 8583 authorization request message, but with a zero or null dollar amount. Other message formats can be used in other embodiments.

In step S112, the authorizing entity computer 108 can review the user information in the provisioning authorization request, and determine if the user device 102 is authorized to receive the wallet account identifier and/or if a token can be created for the primary account number. The provisioning request may be approved or declined depending upon a number of factors including the user's balance in the account associated with the PAN, whether the PAN is potentially fraudulent or stolen, etc. The authorizing entity computer 108 can then send a provisioning response message that approves or declines the request to provision the payment token to the token service computer 106. In some embodiments, the provisioning response message can be in the form of an ISO 8583 authorization response message.

In step S114, if the authorizing entity computer 108 approves of the wallet account identifier provisioning request, the token service computer 106 can record the approval of the request. The token service computer 106 can then transmit a message to the smart contract application 104 indicating that the provisioning request has been approved. In some embodiments, a payment token that is associated with the primary account number can be obtained by the token service computer 106 and can be included in the message. The payment token may be mathematically derived from the primary account number or it can be obtained from a pool of payment tokens in a database at the token service computer 106.

In step S116, the smart contract application 104 can notify the smart contract 110 that the provisioning request was approved, and can request that the smart contract 110 initiate the provisioning of the wallet account identifier. The request can comprise the digital wallet information, the PAN, the payment token, etc.

In step S118, after receiving the indication that the provisioning request was approved, the smart contract 110 can initiate the provisioning of the wallet account identifier. It can do so by generating the wallet account identifier that can service to link the digital wallet information, user information, the primary account number (or other credential), and any optional payment token. The wallet account identifier and its associated information can be stored in the blockchain that also maintains the smart contract 110. After generating the wallet account identifier, the smart contract 110 can send the wallet account identifier to the user device 102. In other embodiments, the smart contract 110 can instruct an external entity (e.g., the token service computer 106) to generate and transmit the wallet account identifier to the user device 102. It is noted that the payment token/wallet account identifier can be sent to the user device 102 from either the smart contract 110 or the smart contract application 104.

In some embodiments, the wallet account identifier can be a wallet account number associated with the digital wallet and a particular credential of the user. In some embodiments, there can be many wallet account identifiers for different credentials in a single wallet. In some embodiments, the wallet account identifier can have the same form as a primary account number. For example, a wallet account identifier could have 16 digits, similar to a PAN. The first six digits of the wallet account identifier can be used to route the wallet account identifier to the token service computer 106. As discussed below, the wallet account identifier can be used to conduct different types of transactions.

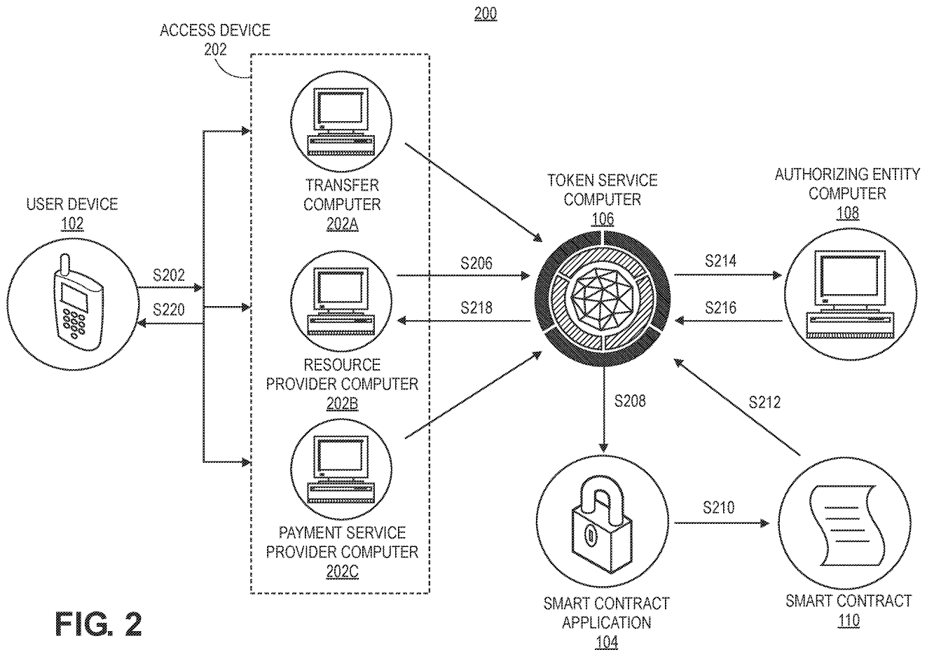

FIG. 2 shows a system and a flow diagram of performing a transaction using a wallet account identifier according to some embodiments. The system can comprise the previously described user device 102, the smart contract application 104, the smart contract 110, the token service computer 106, and the authorizing entity computer 108.

FIG. 2 additionally shows a number of access devices which can include a transport computer 202A, a resource provider computer 202B, and a payment service provider computer 202C. The transport computer 202A could be a computer that is operated by an acquirer. The resource provider computer 202B can be a computer that is operated by a merchant. The payment service provider computer 202C can be operated by a payment service provider that can provide payment processing services to other entities such as merchants. Each of these computers may provide access to a resource desired by the user of the user device 102 and can initiate authorization request messages comprising the wallet account identifier.

In step S202, the user operating the user device 102 may wish to perform a payment transaction with an entity such as a resource provider (e.g., a merchant) operating the resource provider computer 202B using the digital wallet on the user device 102. The resource provider computer 202B can present the transaction details to the user and the user device 102 (e.g., the amount of the transaction, an identifier for the resource provider computer 202B, a description of the items or services purchased, etc.). After reviewing the transaction details, the user device 102 can provide the wallet account identifier associated with the digital wallet obtained from FIG. 1 to the resource provider computer 202B. The user may also optionally indicate to the user device 102 any particular underlying account (e.g., a credit card account number) associated with the wallet account identifier. The user device 102 then provides (e.g., transmits) the wallet account identifier to the resource provider computer 202B.

In step S206, the access device 202 can generate and transmit an authorization request message comprising at least the wallet account identifier and the transaction amount. In some embodiments, the authorization request message can be an ISO 8583 message. The token service computer 106, upon receiving the authorization request message comprising the wallet account identifier, may use the smart contract application 104 and the smart contract 110 to verify the wallet account identifier.

In step S208, the token service computer 106, using the address of the smart contract application 104, can transmit a verification request comprising the wallet account identifier to the smart contract application 104 to verify that the wallet account identifier is valid. In some embodiments, the token service computer 106 can communicate directly with the smart contract 110.

In step S210, after receiving the verification request from the token service computer 106, the smart contract application 104 can transmit the verification request to the smart contract 110 to verify the wallet account identifier. The smart contract 110 is in a blockchain managed by a blockchain network, and can determine that the wallet account identifier is on the blockchain (e.g., by doing a lookup on the blockchain). If the wallet account identifier is in the blockchain and otherwise appears valid to the smart contract 110, then the smart contract validates the wallet account identifier.

In step S212, if the wallet account identifier is valid, the smart contract 110 can provide a verification response to the token service computer 106 (e.g., directly or via the smart contract application 104) indicating that the smart contract 110 has verified the wallet account identifier.

In step S214, upon receiving the verification response, the token service computer 106 can modify the authorization request message by replacing the wallet account identifier with the credential (e.g., PAN) associated with the wallet account identifier. In some embodiments, the token service computer 106 may add the credential to the authorization request message instead of replacing the wallet account identifier with the credential in the authorization request message. In yet other embodiments, if a payment token was previously created by the token service computer 106, then the wallet account identifier may be used to look up the corresponding payment token, which is in turn used to look up the credential (e.g., a primary account number) associated with the wallet account identifier. The token service computer 106 can then initiate transmitting the authorization request message comprising the credential associated with the wallet account identifier to the authorizing entity computer 108. The token service computer 106 can transmit the authorization request message to the authorizing entity computer 108 or can request that another external computer transmit the authorization request message.

In step S216, the authorizing entity computer 108 can determine whether or not to authorize the transaction. For example, the authorizing entity computer 108 may determine if the balance in the account associated with the credential has sufficient funds or credit to pay for the current transaction. The authorizing entity computer 108 can also run any desired fraud or security checks on the authorization request message. The authorizing entity computer 108 can then send an authorization response message whether the authorizing entity computer 108 authorizes or declines the authorization response message.

In step S218, upon receiving the authorization response message from the authorizing entity computer, the token service computer 106 can transmit the authorization response message to the resource provider computer 202B.

In step S220, upon receiving the authorization response message from the token service computer 106, the access device 202 can transmit the authorization response message to the user device 102. The user operating the user device 102 can be notified whether the payment transaction is successful or not.

At the end of the day or at any other suitable period of time, a clearing and settlement process can occur between an acquirer of the resource provider operating the resource provider computer 202B, the authorizing entity computer 108, and a processing network such as a payment processing network.

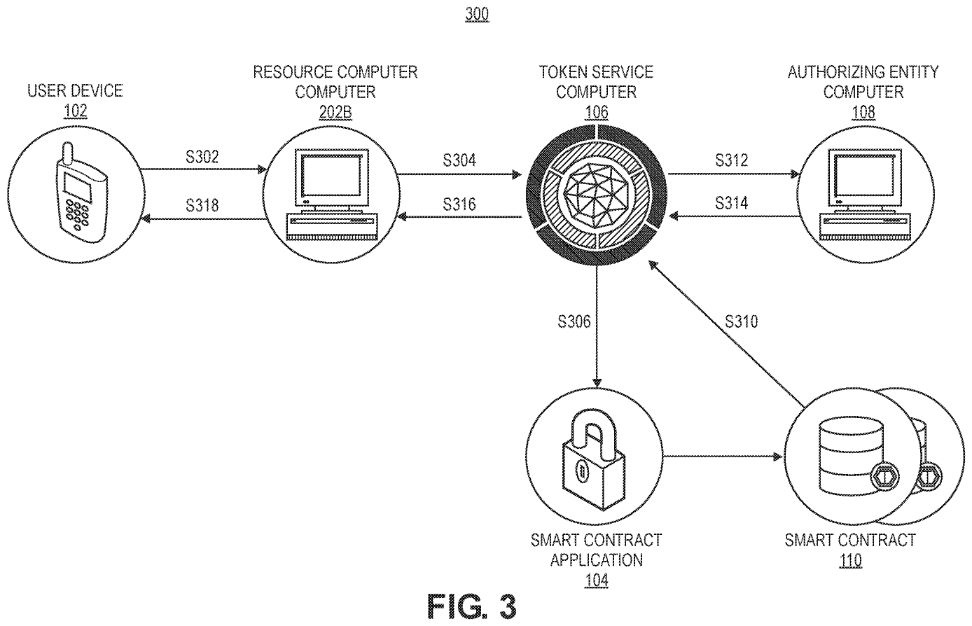

FIG. 3 shows a flow diagram of a system and a flow diagram for obtaining a digital asset from a resource provider operating a resource provider computer 202B. The flow diagram can comprise the previously described user device 102, the smart contract application 104, the smart contract 110, the token service computer 106, the authorizing entity computer 108, and the resource provider computer 202B. The resource provider computer 202B can be a Web server that manages or distributes digital assets such as NFT (non-fungible tokens). The user may wish to pay for the digital asset using a traditional payment credential such as a primary account number.

In step S302, the user using the user device 102 can perform a payment transaction with the resource provider computer 202B. The user can cause the user device 102 to provide payment credential information such as PAN, CVV2, etc. to the resource provider computer 202B to perform the payment transaction, and other information such an optional as a flag indicating that a wallet account identifier is associated with the payment credential or a transaction type indicator indicating the type of transaction to be performed. Different transaction types can include sending one type of currency from one account to another type of currency in another account, a payment transaction for a physical asset or service, a payment transaction for a digital asset, etc.

In step S304, the resource provider computer 202B can generate and transmit an authorization request message to the token service computer 106. The authorization request message can comprise the payment credential, and optionally the transaction type indicator and the flag indicating that a wallet account identifier is associated with the payment credential. If the flag is not present, the resource provider computer 202B can additionally send a request to the token service computer 106 to check if the payment credential (e.g., PAN) has a corresponding wallet account identifier with the token service computer 106.

In step S306, upon receiving the request to check if the payment credential has a corresponding wallet account identifier, the token service computer 106 can send the payment credential to the smart contract application 104.

In step S308, the smart contract application 104 can determine if there is a wallet account identifier that corresponds to the payment credential by communicating with the smart contract 110 on the blockchain network. In other embodiments, the token service computer 106 or the smart contract 110 can check to see if there is already an existing mapping between the user's payment credential (e.g., PAN) and a wallet identification number/token.

In step S310, upon receiving the payment credential from the smart contract application 104, the smart contract 110 can determine if there is a corresponding payment credential in the blockchain network. If the smart contract 110 finds the payment credential, then the smart contract 110 can determine the wallet account identifier associated with the payment credential. The smart contract 110 can then send the wallet account identifier to the token service computer 106.

In step S312, if the wallet account identifier is found, the token service computer 106 can transmit an authorization request message comprising the payment credential to the authorizing entity computer 108.

In step S314, the authorizing entity computer 108 can then approve or decline the authorization request message (similar to the process described in with respect to FIG. 2). The authorizing entity computer 108 can then send an authorization response message whether the authorization is accepted or declined to the token service computer 106.

In step S316, the token service computer 106 can transmit the authorization response message and the wallet account identifier associated with the payment credential to the resource provider computer 202B.

In step S318, the resource provider computer 202B can deliver a digital asset to the digital wallet associated with wallet account identifier once the transaction processes and clears. The resource provider computer 202B may communicate with the smart contract 110 to find the public address (e.g., public key) of the digital wallet associated with wallet account identifier to deliver the digital asset to the digital wallet. For example, the resource provider computer 202B may provide a non-fungible token (NFT) to the digital wallet in response to the conducted transaction. In other embodiments, the transaction that was conducted can be for a different type of resource, and the transfer of a digital asset such as a non-fungible token to the digital wallet of the user can be a reward to the user for conducting the transaction. The NFT may be written to a blockchain.

At the end of the day or at any other suitable period of time, a clearing and settlement process can occur between an acquirer of the resource provider operating the resource provider computer 202B, the authorizing entity computer 108, and a processing network such as a payment processing network.

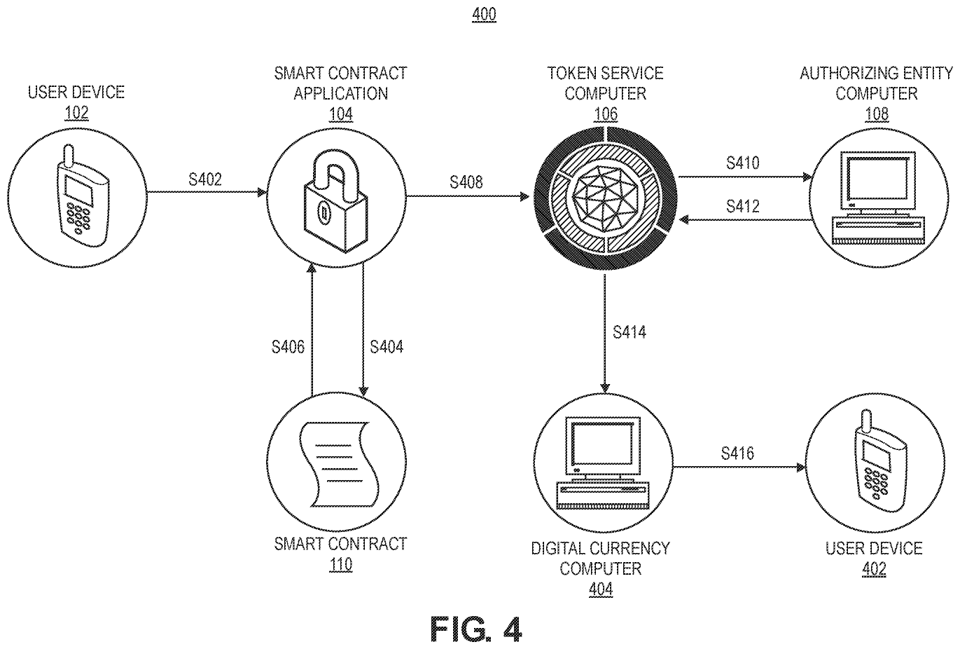

FIG. 4 shows a system and a flow diagram for one user sending funds using a primary account number to another user that has a wallet account identifier. The system can comprise the user device 102, the smart contract application 104, the smart contract 110, the token service computer 106, and the authorizing entity computer 108. The system can also comprise a digital currency computer 404 and another user device 402.

In step S402, the user (e.g., a first user) using the user device 102 (e.g., a first user device) can transmit a value transfer message comprising the wallet account identifier of the user (e.g., a second user) operating the user device 402 (e.g., a second user device), a value, and a wallet account identifier of the user operating the user device 102 to the smart contract application 104.

In step S404, the smart contract application 104 can send a request to find a public address (e.g., a public key) of a digital wallet associated with the wallet account identifier of the user of the user device 402 to the smart contract 110. The smart contract 110 can look through the blockchain on the blockchain network to find the public address of a digital wallet associated with the wallet account identifier of the user device 402.

In step S406, if the public address of the digital wallet associated with the user of the user device 402 is found, the smart contract 110 can send the public address of the digital wallet of the user of the user device 402 to the smart contract application 104.

In step S408, after receiving the public address of the digital wallet of the user operating the user device 402 and the credential of the user operating the user device 102, the smart contract application 104 can generate and transmit an authorization request message comprising the value, the public address of the digital wallet of the user operating the user device 402, and the wallet account identifier associated with the user device 102 to the token service computer 106.

In step S410, upon receiving the authorization request message, the token service computer 106 can find a payment credential (e.g., PAN) associated with the wallet account identifier of the user operating the user device 102. The token service computer 106 can then replace the wallet account identifier with the payment credential and send the authorization request message to the authorizing entity computer 108. In some embodiments, the public address of the digital wallet of the user operating the user device 402 can be removed from the authorization request message that is sent to the authorizing entity computer 108.

In step S412, the authorizing entity computer 108 can authorize or decline the authorization request message as described above. The authorizing entity computer 108 can then send an authorization response message whether the authorizing entity computer 108 authorizes or declines the authorization response message.

In step S414, upon authorizing the authorization request, the token service computer 106 can send a request to the digital currency computer 404 to convert the value in the authorization request message, which is in fiat currency, to a digital asset such as digital currency (e.g., cryptocurrency). The digital currency computer 404 can be, for example, a cryptocurrency exchange, which can exchange fiat currency for cryptocurrency, and vice-versa.

In step S416, the digital currency computer 404 can convert the fiat currency value into the digital asset. Upon conversion, the digital currency computer 404 can transmit the digital asset to digital wallet of the user device 402 by sending the value to the public address of the digital wallet on the blockchain of the blockchain network, or another blockchain (e.g., a Bitcoin or Ethereum blockchain).

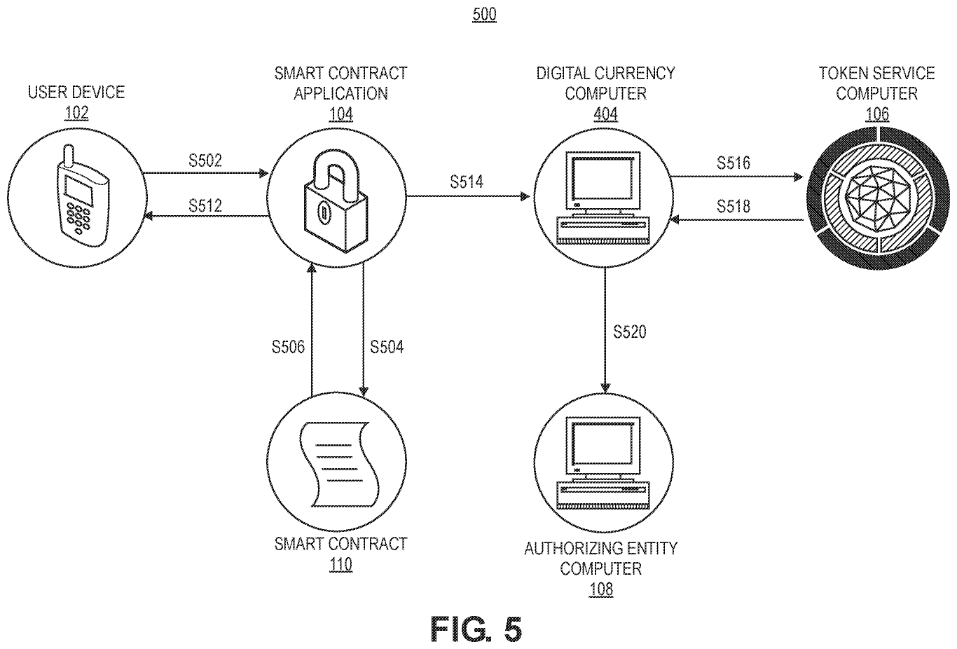

FIG. 5 shows a flow diagram of converting the digital currency into fiat currency using a wallet account identifier. The flow diagram can comprise the user device 102, the smart contract application 104, the smart contract 110, the token service computer 106, the authorizing entity computer 108, the digital currency computer 404, and a digital currency conversion computer 502.

In step S502, the user can send a request to convert digital assets (e.g., digital currency) into a fiat currency to the smart contract application 104. The request can comprise the wallet account identifier of the digital wallet associated with the user device 102.

In step S504, the smart contract application 104 can verify that the user device 102 possesses a valid wallet account identifier by using the smart contract 110.

In step S506, the smart contract 110 can check if the wallet account identifier associated with the user device 102 is on the blockchain network. If the smart contract 110 can find the wallet account identifier, the smart contract 110 can send a response that the wallet account identifier is valid.

In step S514, the smart contract application 104 can send a push request comprising the wallet account identifier and the digital assets to convert the digital assets into fiat currency to the digital currency computer 404.

In step S516, the digital currency computer 404 can send the wallet account identifier to the token service computer 106 to identify payment credential (e.g., PAN, routing number).

In step S518, upon receiving the wallet account identifier, the token service computer 106 can find the payment credential associated to the wallet account identifier. The token service computer 106 can send the payment credential to the digital currency computer 404.

In step S520, the digital currency computer 404 can convert the digital assets into a fiat currency and push it to the payment credential associated with the wallet account identifier. In some embodiments, the digital currency computer 404 can generate and transmit an OCT (original credit transaction) message to the authorizing entity computer 108 via a payment processing network. The OCT message can credit a credential such as primary account number with an amount of fiat currency. A settlement can occur at a later time between the digital currency computer 404, the payment processing network, and the authorizing entity computer 108.

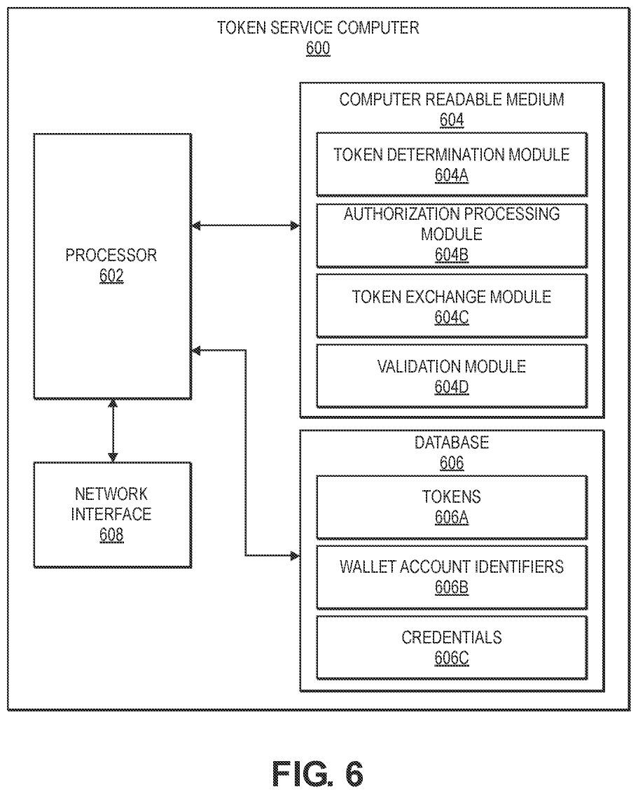

FIG. 6 shows a token service computer 600. The token service computer 600 includes a processor 602 and a computer readable medium 604, a database 606, and a network interface 608 coupled to the processor 602.

The computer readable medium 604 may comprise a token determination module 604A, an authorization processing module 604B, a token exchange module 604C, and a validation module 604D.

The token determination module 604A may comprise code that cases the processor 602 to determine a token. As noted above, a token can be mathematically derived from a credential, or it may be retrieved from a pool of available tokens.

The authorization processing module 604B can comprise code that causes the processor 602 to generate, transmit and otherwise process authorization request and response messages.

The token exchange module 604C may comprise code that causes the processor 602 to exchange tokens for credentials, and vice-versa. It may also comprise code that causes the processor 602 to exchange wallet account identifiers for credentials or tokens, and vice versa.

The validation module 604D may comprise code that causes the processor 602 to validate token requests before a payment token is provided. For example, validation module 604D may contain logic that causes the processor 602 to confirm that a token request message is authentic by decrypting a cryptogram included in the message, by confirming that the payment credentials are authentic and associated with the requesting device, by assessing risk associated with the requesting device.

The computer readable medium 604 may also comprise code, executable by the processor 602 to perform operations comprising: transmitting a verification request comprising a wallet account identifier associated with a digital wallet to a smart contract on a blockchain network or a smart contract application associated with the smart contract, wherein the smart contract or the smart contract application verifies the wallet account identifier using a blockchain on the blockchain network; receiving, by the computer from the smart contract on the blockchain network or the smart contract application, a verification response verifying the wallet account identifier; and initiating transmitting to an authorizing entity computer, an authorization request message comprising a credential associated with the wallet account identifier, wherein the authorizing entity computer authorizes the authorization request message.

The computer readable medium 604 may also comprise code, executable by the processor 602 to perform operations comprising: receiving, from an access device, an authorization request message comprising a wallet account identifier comprising a wallet account number; transmitting, by the token service computer, a verification request comprising the wallet account identifier comprising the wallet account number to a smart contract on a blockchain network or a smart contract application associated with the smart contract, wherein the smart contract or the smart contract application verifies the wallet account identifier comprising the wallet account number using a blockchain on the blockchain network; receiving, by the token service computer from the smart contract on the blockchain network or the smart contract application, a verification response verifying the wallet account identifier comprising the wallet account number; transmitting, by the token service computer to an authorizing entity computer, an authorization request message comprising a credential, wherein the authorizing entity computer authorizes the authorization request message and transmits an authorization response message to the token service computer; receiving, by the token service computer, the authorization response message; and transmitting, by the token service computer, the authorization response message to the access device.

The database 606 can store tokens 606A, wallet account identifiers 606B, and credentials 606C. The database 606 can store records which can link wallet account identifiers to their associated credentials and tokens (which are optional). The database can also comprise transaction type indicators including a first transaction type indicator indicating that a transaction is conducted using the credential and a second transaction type indicator indicating that a transaction is a transaction that is recorded on the blockchain or is otherwise processed using the blockchain.

The network interface 608 may include an interface that can allow the token service computer 600 to communicate with external computers. Some examples of the network interface 608 may include a modem, a physical network interface (such as an Ethernet card or other Network Interface Card (NIC)), a virtual network interface, a communications port, a Personal Computer Memory Card International Association (PCMCIA) slot and card, or the like. The wireless protocols enabled by the network interface 206 may include Wi-Fi™. Data transferred via the network interface 608 may be in the form of signals which may be electrical, electromagnetic, optical, or any other signal capable of being received by the external communications interface (collectively referred to as “electronic signals” or “electronic messages”). These electronic messages that may comprise data or instructions may be provided between the network interface 608 and other devices via a communications path or channel. As noted above, any suitable communication path or channel may be used such as, for instance, a wire or cable, fiber optics, a telephone line, a cellular link, a radio frequency (RF) link, a WAN or LAN network, the Internet, or any other suitable medium.

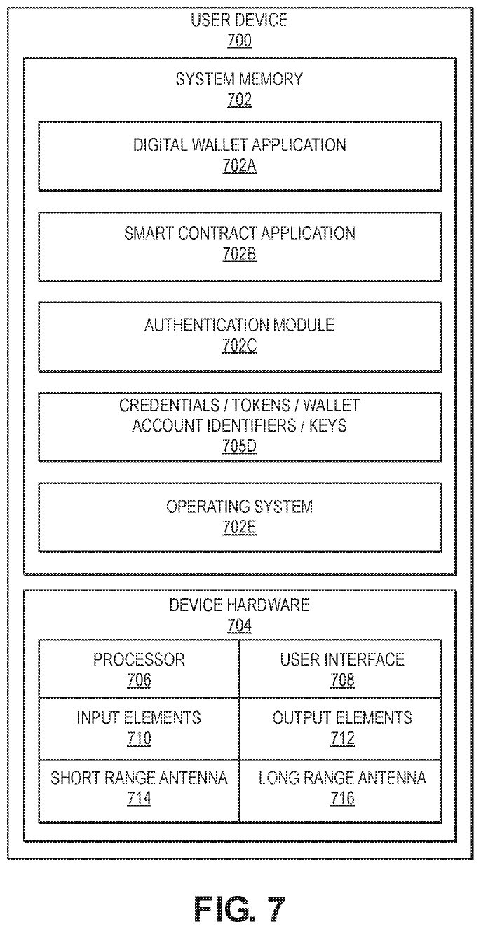

FIG. 7 shows a block diagram of a user device 700 in according to an embodiment. The user device 700 may include device hardware 704 coupled to a system memory 702.

Device hardware 704 may include a processor 706, a short range antenna 714, a long range antenna 716, input elements 710, a user interface 708, and output elements 712 (which may be part of the user interface 708). Examples of input elements may include microphones, keypads, touchscreens, sensors, etc. Examples of output elements may include speakers, display screens, and tactile devices.

The long range antenna 716 may include one or more RF transceivers and/or connectors that can be used by user device 700 to communicate with other devices and/or to connect with external networks. The user interface 708 can include any combination of input and output elements to allow a user to interact with and invoke the functionalities of user device 700. The short range antenna 714 may be configured to communicate with external entities through a short range communication medium (e.g., using Bluetooth, Wi-Fi, infrared, NFC, etc.). The long range antenna 716 may be configured to communicate with a remote base station and a remote cellular or data network, over the air.

The system memory 702 can be implemented using any combination of any number of non-volatile memories (e.g., flash memory) and volatile memories (e.g., DRAM, SRAM), or any other non-transitory storage medium, or a combination thereof media.

The system memory 702 may also store a digital wallet application 702A, a smart contract application 702B, an authentication module 702C, credentials, tokens, wallet account identifiers, and cryptographic keys 702D, and an operating system 702E, The authentication module 702C may comprise code, executable by the processor 706, to authenticate a user. This can be performed using user secrets (e.g., passwords) or user biometrics.

The system memory 702 may also comprise a computer readable medium comprising code, executable by the processor 706, to perform operations comprising: receiving, by a smart contract application residing on a computer, information of a user; receiving, by the smart contract application on the computer, an authorization from a smart contract on a blockchain network to proceed with provisioning of a wallet account identifier; sending by the smart contract application on the computer a request to provision the wallet account identifier to a token service computer; receiving, by the smart contract application on the computer, a response approving of the provisioning of the wallet account identifier; transmitting, by the smart contract application on the computer to the smart contract on the blockchain network, the request to provision the wallet account identifier to a user device of the user, wherein the smart contract thereafter initiates provisioning of the wallet account identifier to a user device of the user.

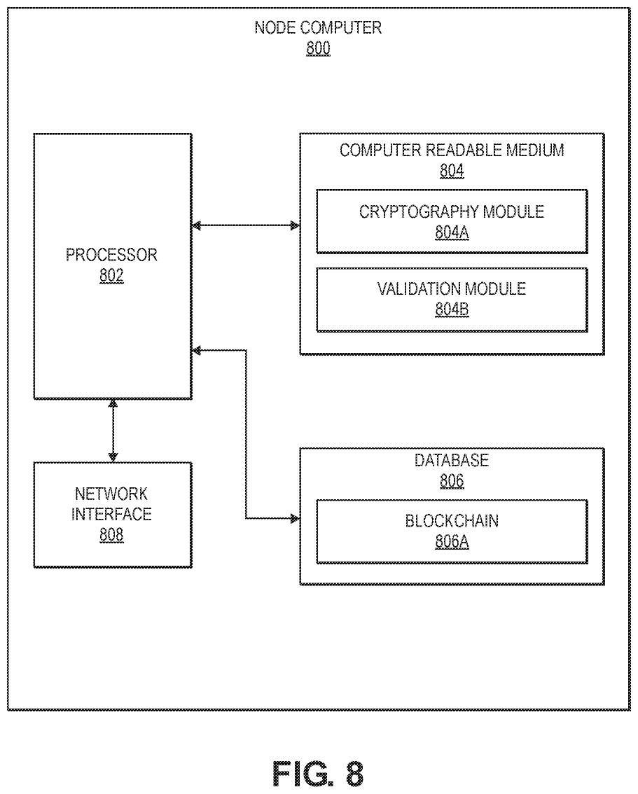

FIG. 8 shows a block diagram of a node computer 800 in a blockchain network. The node computer 800 includes a processor 802 and a computer readable medium 804, a database 806, and a network interface 808 coupled to the processor 802. The network interface 808 can have the same or different characteristics as the network interface described in FIG. 6. The database 806 may comprise a blockchain 806A, which may store entries for provisioning or payment transactions and smart contracts.

The computer readable medium 804 may comprise a cryptography module 804A, a validation module 804B, and a search module 804C.

The cryptography module 804A can comprise code, executable by the processor 802 to perform cryptographic operations including signing data with private keys, validating digital signatures with public keys, and encrypting or decrypting data with cryptographic keys.

The validation module 804B can comprise code, executable by the processor 802 to validate transactions before they are recorded to the blockchain 806A. In some embodiments, the validation module 804B can use a proof of work, or consensus type validation system. The validation module 804B can also comprise code, executable by the processor 802 for determine if data such as a wallet account identifier is on the blockchain 806A.

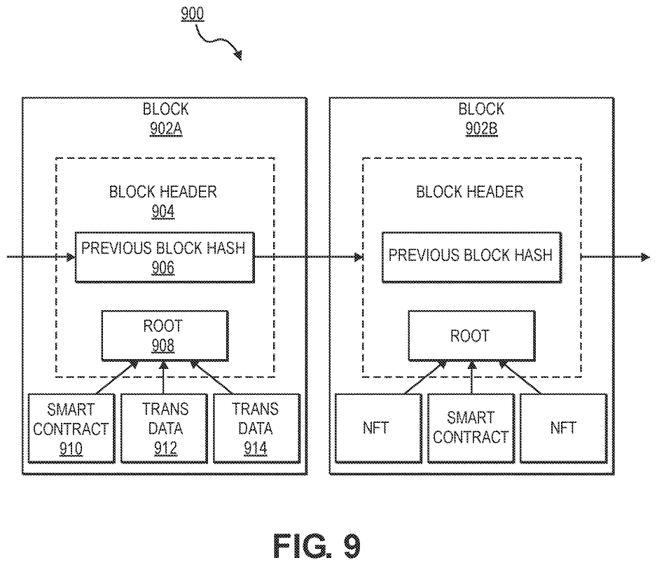

FIG. 9 shows a block diagram illustrating a portion of a blockchain according to embodiments. A blockchain portion 900 can include a list of blocks of tokens, the blocks are cryptographically chained together as depicted in FIG. 9. A block is created by a computationally intensive process called proof-of-work in which valid blocks need to demonstrate a sufficient “difficulty” (e.g., sufficient computation power to create on average). In some embodiments, the blockchain can utilize a proof-of-stake process rather than a proof-of-work process. If there are more than one available chains of blocks, then network participants (e.g., nodes) need to download all blocks in all chains and follow the chain which has the highest total difficulty. This mechanism guarantees that, eventually, the network will agree on a single and valid chain.

FIG. 9 shows an example blockchain format. However, it is understood that other formats and data structures can be utilized. The blockchain portion 900 can comprise a plurality of blocks, for example, block 902A and block 902B. Each block can comprise a block header, for example, block 902A comprises block header 904.

The block header 904 can include multiple data elements, such as a previous block hash 906 and a Merkle root 908. The Merkle root 908 can be a root of a Merkle tree, which is a tree in which every leaf node is associated with a hash of data such data forming the smart contract 910, transactions 912, 914, digital assets such as NFTs, etc.

Embodiments of the invention have a number of advantages. Through the use of a wallet account identifier and a smart contract on a blockchain, transactions conducted between fiat currencies and digital currencies can occur seamlessly and with fewer steps relative to conventional systems which need to interface fiat currency systems and digital currency systems. Further, since a blockchain is used to record the creation and provisioning of the wallet account identifier, various parties can verify that the wallet account identifier is legitimate and authentic. Still further, since the data regarding provisioning and interactions with the wallet account identifier are recorded on a blockchain, the record of such use on the blockchain is tamperproof and immutable.

Any of the software components or functions described in this application may be implemented as software code to be executed by a processor using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g., a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

As used herein, the use of “a,” “an,” or “the” is intended to mean “at least one,” unless specifically indicated to the contrary.

1. A method of conducting a transaction comprising:
transmitting, by a computer, a verification request comprising a wallet account identifier associated with a digital wallet to a smart contract on a blockchain network or a smart contract application associated with the smart contract, wherein the smart contract or the smart contract application verifies the wallet account identifier using a blockchain on the blockchain network;
receiving, by the computer from the smart contract on the blockchain network or the smart contract application, a verification response verifying the wallet account identifier; and
initiating transmitting to an authorizing entity computer, an authorization request message comprising a credential associated with the wallet account identifier, wherein the authorizing entity computer authorizes the authorization request message.

2. The method of claim 1, wherein the computer is a token service computer, and wherein the method further comprises,
before transmitting the wallet account identifier:
receiving, by the token service computer from an access device, the authorization request message comprising the wallet account identifier; and
after transmitting the authorization request message:
receiving, by the token service computer, an authorization response message from the authorizing entity computer; and
transmitting, by the token service computer, the authorization response message to the access device.

3. The method of claim 1, wherein the method further comprises,
before transmitting the wallet account identifier:
receiving, by the computer from a user device of a first user, a value transfer message comprising the wallet account identifier, a value, and a credential of a second user.

4. The method of claim 3, wherein initiating transmitting to the authorizing entity computer, the authorization request message comprising the credential associated with the wallet account identifier comprises transmitting by the computer the authorization request message to a token service computer, which exchanges the wallet account identifier for the credential, and then transmits the authorization request message to the authorizing entity computer with the credential.

5. The method of claim 1, wherein initiating transmitting to the authorizing entity computer, the authorization request message comprising the credential associated with the wallet account identifier comprises transmitting to the authorizing entity computer, the authorization request message comprising the credential associated with the wallet account identifier.

6. The method of claim 1, wherein the smart contract verifies the wallet account identifier by determining that the wallet account identifier is on the blockchain.

7. The method of claim 1, wherein transmitting the wallet account identifier to the smart contract on the blockchain network comprises transmitting the wallet account identifier to the smart contract on the blockchain network via the smart contract application.

8. The method of claim 7, wherein the smart contract application is on a cloud server computer.

9. The method of claim 1, wherein the computer is a token service computer, and wherein the method further comprises,
before transmitting the wallet account identifier:
receiving, by the token service computer from an access device operated by a resource provider computer, the authorization request message comprising the wallet account identifier; and
after transmitting the authorization request message:
receiving, by the token service computer, an authorization response message from the authorizing entity computer; and
transmitting, by the token service computer, the authorization response message to the access device.

10. The method of claim 1, wherein the authorization request message is an ISO 8583 message.

11. The method of claim 1, wherein the blockchain network is a public blockchain network.

12. The method of claim 1, wherein the authorization request message comprises a transaction type indicator.

13. The method of claim 12, wherein the transaction type indicator indicates that the transaction is to be conducted with the credential.

14. The method of claim 1, wherein the computer comprises a database comprising transaction type indicators including a first transaction type indicator indicating that a transaction is conducted using the credential and a second transaction type indicator indicating that a transaction is a transaction that is recorded on the blockchain.

15. A token service computer comprising:
a processor; and
a computer readable medium comprising code, executed by the processor for performing operations comprising:
transmitting a verification request comprising a wallet account identifier associated with a digital wallet to a smart contract on a blockchain network or a smart contract application associated with the smart contract, wherein the smart contract or the smart contract application verifies the wallet account identifier using a blockchain on the blockchain network;
receiving, from the smart contract on the blockchain network or the smart contract application, a verification response verifying the wallet account identifier; and
initiating transmitting to an authorizing entity computer, an authorization request message comprising a credential associated with the wallet account identifier, wherein the authorizing entity computer authorizes the authorization request message.

16. A method comprising:
receiving, by a smart contract application residing on a computer, information of a user;
receiving, by the smart contract application on the computer, an authorization from a smart contract on a blockchain network to proceed with provisioning of a wallet account identifier;
sending by the smart contract application on the computer a request to provision the wallet account identifier to a token service computer;
receiving, by the smart contract application on the computer, a response approving of the provisioning of the wallet account identifier; and
transmitting, by the smart contract application on the computer to the smart contract on the blockchain network, the request to provision the wallet account identifier to a user device of the user, wherein the smart contract thereafter initiates the provisioning of the wallet account identifier to the user device of the user.

17. The method of claim 16, wherein the computer is a cloud based computer.

18. The method of claim 16, wherein the user device is a mobile phone of the user.

19. The method of claim 16, wherein the wallet account identifier is a wallet account number associated with a digital wallet.

20. The method of claim 19, wherein the wallet account identifier is capable of conducting transactions using an authorizing entity computer or the blockchain network.

21.-23. (canceled)
